(19) United States
(12) Patent Application Publication
(10) Pub. No.: US 2006/0042444 A1
(43) Pub. Date: Mar. 2, 2006

(54) Miter saw having two laser oscillators

(76) Inventors: Shigeharu Ushiwata, Hitachinaka-shi (JP); Takamoto Horiuchi, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/214,855

(22) Filed: Aug. 31, 2005

(30) Foreign Application Priority Data
Aug. 31, 2004 (JP) P2004-251326

(51) Int. Cl. B26D 5/08

(52) U.S. Cl. 83/581

(57) ABSTRACT

A miter saw having first and second laser oscillators. A base is provided for mounting a worpiece. A fence extends in a lateral direction and is fixed to the base and has a front surface to which the workpiece is to be abutted. A cutting unit rotatably supports a circular saw blade. A support section is supported on the base and is pivotably supports the cutting unit movable toward and away from the base. The first laser oscillator is provided at the base for irradiating a first laser beam to the front side of the workpiece. The second laser oscillator is provided at the support section for irradiating a second laser beam to a rear side of the workpiece.

### BACKGROUND OF THE INVENTION

The present invention relates to a miter saw, and more particularly, to the miter saw having two laser oscillators.

For cutting a workpice by a miter saw, a marking line indicative of a cutting line is provisionally drawn on a surface of the workpiece, and a cutting is performed along the marking line. However, the marking line may be covered with cutting chips and becomes invisible, to degrade cutting efficiency.

In order to avoid this problem, Japanese Patent Application Publication No. 2000-225603 discloses a miter saw provided with a laser oscillator which irradiates a laser beam so that the cutting can be performed along a laser beam projection line on an upper surface of a workpiece.

The laser beam projection line can be easily recognized if the upper surface of the workpiece is flat. However, if the upper surface contains convex or concave regions, or wavy form such as a molding segment, the laser beam may generate a shadow area to degrade visibility to the cutting line.

### SUMMARY OF THE INVENTION

It is therefore, an object of the present invention to provide a miter saw capable of providing a clear laser beam projection line even if the laser irradiated surface of the workpiece is three dimensionally irregularly shaped.

This and other objects of the present invention will be attained by a miter saw including a base, a cutting unit, a support section, a fence, a first laser oscillator, and a second laser oscillator. The base is adapted for mounting thereon a workpiece. The cutting unit is adapted for rotatably supporting a circular saw blade. The support section is supported on the base and pivotably supports the cutting unit movable toward and away from the base. The fence extends in a lateral direction and is fixed to the base and has a front surface to which the workpiece is to be abutted. The first laser oscillator irradiates a first laser beam to the workpiece from a front side of the front surface. The second laser oscillator irradiates a second laser beam to the workpiece from a rear side of the front surface.

### BRIEF DESCRIPTION OF THE DRAWINGS

In the drawings:

FIG. 1 is a side view showing a miter saw according to a first embodiment of the present invention;

FIG. 2 is a partial view showing a tilt mechanism in the miter saw according to the first embodiment;

FIG. 3 is a front side view showing the miter saw according to the first embodiment;

FIG. 4 is a circuit diagram showing a laser oscillator in the miter saw according to the first embodiment;

FIG. 5(a) is a perspective view showing a second laser beam irradiated within the thickness of the saw blade for defining a cutting width on a workpiece according to the first embodiment;

FIG. 5(b) is a cross-sectional view showing the second laser beam irradiated within the thickness of the saw blade for defining the cutting width on the workpiece; according to the first embodiment

FIG. 6(a) is a perspective view showing a first laser beam irradiated outside of the thickness of the saw blade for defining a cutting width on the workpiece according to the first embodiment;

FIG. 6(b) is a cross-sectional view showing the first laser beam irradiated without of the thickness of the saw blade for defining a cutting width on the workpiece according to the first embodiment;

FIG. 7(a) is a perspective view showing the second laser beam irradiated within the thickness of the saw blade and the first laser beam irradiated outside of the thickness of the saw blade for defining a cutting width on the workpiece according to the first embodiment;

FIG. 7(b) is a cross-sectional view showing the second laser beam irradiated within the thickness of the saw blade and the first laser beam irradiated outside of the thickness of the saw blade for defining the cutting width on the workpiece according to the first embodiment;

FIG. 8(a) is a perspective view showing the first laser beam and the second laser beam those irradiated outside of the thickness of the saw blade respectively for defining a cutting width on the workpiece;

FIG. 8(b) is a cross-sectional view showing the first laser beam and the second laser beam those irradiated outside of the thickness of the saw blade respectively for defining the cutting width on the workpiece according to the first embodiment;

FIG. 9 is a side-perspective view showing a fine adjustment mechanism of laser oscillator in the miter saw according to the first embodiment;

FIG. 10 is a cross-sectional view taken along the line X-X of FIG. 9;

FIG. 11 is a cross-sectional view taken along the line XI-XI of FIG. 10;

FIG. 12 is a cross-sectional view taken along the line XII-XII of FIG. 9;

FIG. 13 is a cross-sectional view taken along the line XIII-XIII of FIG. 10;

FIG. 14 is a cross-sectional view taken along the line XIV-XIV of FIG. 13;

FIG. 15 is a side view showing a miter saw according to a second embodiment of the present invention;

FIG. 16 is a partial view showing a tilt mechanism in the miter saw according to the second embodiment;

FIG. 17 is a front side view showing the miter saw according to the second embodiment;

FIG. 18 is a side view showing a first modification to the second embodiment of the present invention; and

FIG. 19 is a side view showing a second modification to the second embodiment of the present invention.

### DETAILED DESCRIPTION OF THE PREFERRED EMBODIMENTS

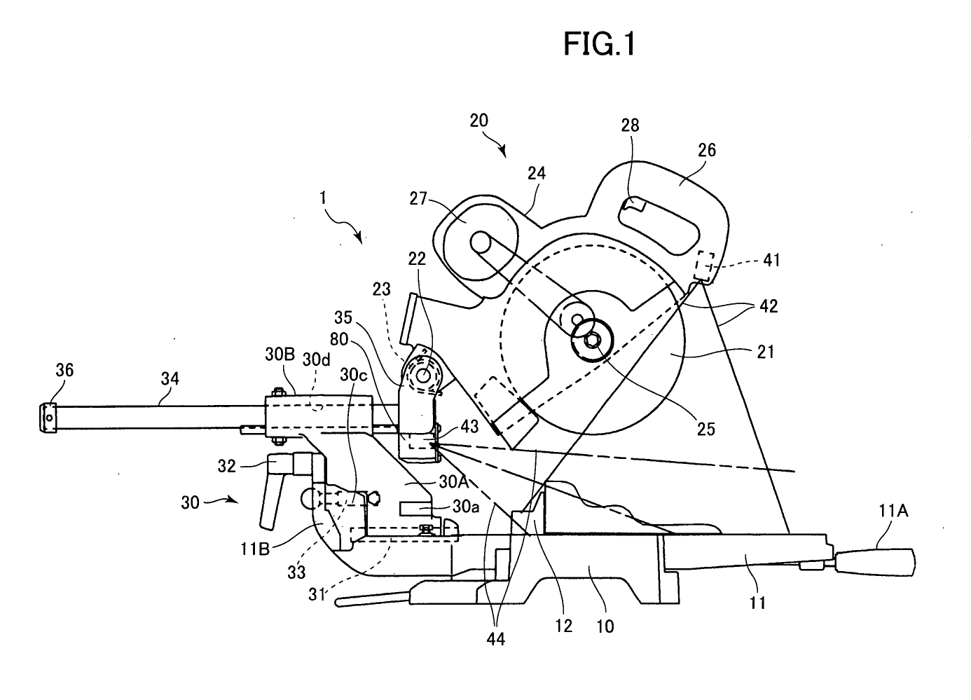

A miter saw according to a first embodiment of the invention will be described with reference to FIG. 1 to FIG. 14. As shown in FIG. 1, the miter saw 1 includes a base 10, a turntable 11, a cutting unit 20, and a support section 30. The turntable 11 is supported on the base 10 and is rotatable about its axis with respect to the base 10. The cutting unit 20 holds a circular saw blade 21. The support section 30 stands upright from the rear portion of the turntable 11 to be pivotally movable. The support section 30 supports the cutting unit 20 movable toward and away from the turntable 11.

The turntable 11 is fitted, at its center part, in the base 10 and is angularly rotatable in a horizontal plane. The upper surface of the turntable 11 is substantially flush with the upper surface of the base 10. A workpiece W such as a wood block is placed on the upper surfaces of the base 10 and turntable 11. A pair of fences 12 are secured to the upper surface of the base 10 and extend across the turntable 11 or along the diameter thereof. As shown in FIG. 3, the fence 12 has a front surface serving as an abutment surface 12A on which the workpiece W is abutted for positioning the workpiece W. Note that the fences 12 are arrayed in a row that extends from the left to the right across the base 10. The pair of fences 12 are spaced apart from each other at their inner ends, thus avoiding interference with the circular saw blade 21. Hereafter, throughout the specification, the abutment surface 12A side of the fences 12 is defined as a front side of the miter saw 1, and a rear side of the fence 12 opposite to the abutment surface 12A is defined as a rear side of the miter saw 1. A place of the cutting unit 20 side relative to the base 10 is defined as an upper side of the miter saw 1, and a place of the base 10 side about the cutting unit 20 is defined as a lower side of the miter saw 1. Then, a right side and a left side is defined in FIG. 3 as viewed from the front side of the miter saw 1.

As shown FIG. 1, a handle 11A extends from the turntable 11 radically outwardly and at the front side of the base 10. The turntable 11 can be angularly rotated about its axis relative the base 10 by moving the handle 11A rightward or leftward. A pair of plates (not shown) is fixed to the upper surface of the turntable 11. The pair of plates are separated from each other to provide a groove extending in a diametrical direction of the turntable 11 to allow a part of the circular saw blade 21 to be entered into the groove. Therefore, generation of fluff at the lower surface of the workpiece W can be prevented when the lower end of the circular saw blade 21 is moved past the upper surface of the turntable 11 during cutting, while the circular saw blade 21 is entered into the groove.

The support section 30 includes a holder 30A, a guide bar 34, and a cutting unit support 35. The holder 30A is supported tiltable about a holder shaft 31 on the turntable 11. An axial direction of the holder shaft 31 coincides with a direction of the groove on the surface of the turntable 11. Therefore, the holder 30A is tiltingly movable about the holder shaft 31 to right side or left side. when the holder 30A has pivotally moved, the circular saw blade 21 can enter the groove. Further, the groove has a sufficient width for allowing the past of the circular saw blade 21 to be entered therein even if the circular saw blade 21 is tilted leftward or rightward.

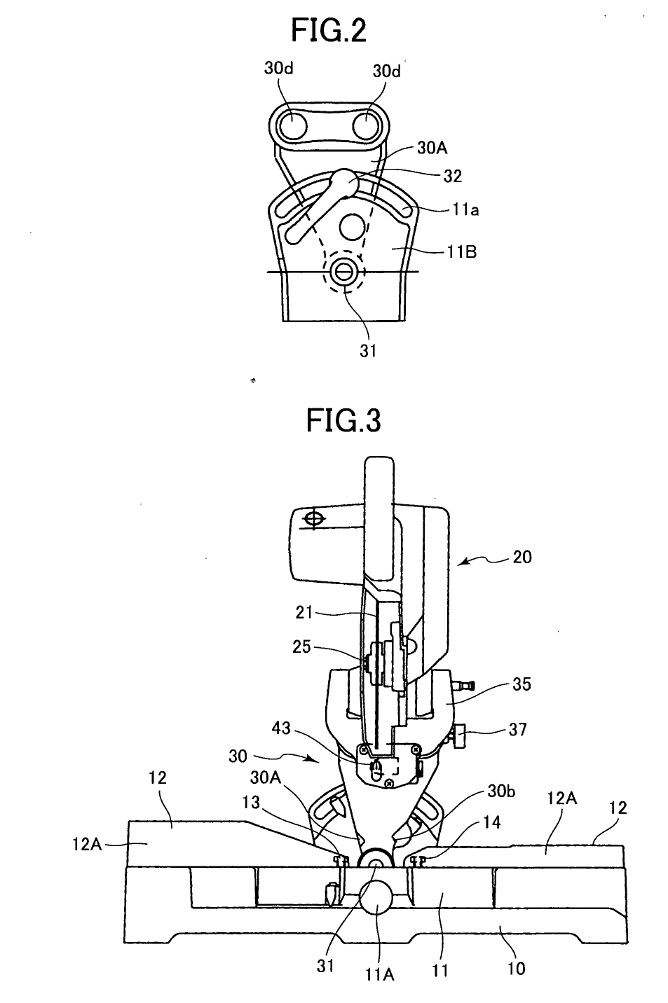

A bracket 11B extends vertically from a rear part of the turntable 11. The bracket 11B is formed with an arcuate slot 11a (Shown FIG. 2). An imaginary center of radius of the arcuate slot 11a is coincident with the holder shaft 31. The holder 30A is formed with a hole (not shown) at a position in alignment with the arcuate slot 11a. A clump lever 32 has a screw part, which is threadingly engaged with the hole (not shown) of the holder 30A passing through the arcuate slot 11a. If the clump lever 32 is unfastened, the holder 30A becomes tiltable about the axis of the holder shaft 31 as long as the clump lever moves relative to the arcuate slot 11a. When the clump lever 32 is fastened, the clump lever 32 and the holder 30A fixedly interpose therebetween the bracket 11B. Thus, the holder 30A can be held at a desired inclined posture. The arcuate slot 11a has such a length that the holder 30A can be moved between the up-right position (hereinafter referred to as ”right-angle cutting position”) where the holder 30A stands at right angles to the base 10 and inclined position where the holder 30A inclines at 45° to the left and to the right in FIG. 2.

As shown in FIG. 3, at the front part of the holder 30A, stop recesses 30a and 30b are formed. The stop recesses 30a and 30b are located near the base end part of the holder 30A the base end part being positioned close to the turntable 11. The stop recesses 30a and 30b extend from the front side of the holder 30A to the rear side thereof. Screw holes extending vertically are formed at the upper surface of the rear part of the turntable 11. Stop bolts 13 and 14 are threadingly engaged with the screw holes. Heads of the stop bolts 13 and 14 are located above the upper surface of the turntable 11. The heads of the stop bolts 13 and 14 can be controllable so as to define the rightmost and leftmost tilted positions of the holder 30A. That is, when the holder 30A is tilted leftward of rightward, one of the stop recesses 30a and 30b is brought into abutment with associated one of the heads of the stop bolts 13 and 14. Thus, the holder 30A is hold inclined at the leftmost position or rightmost position. The stop bolt 13 abuts on the stop recess 30a when the holder 30A is tilted to the leftward and inclined at 45°, and the stop bolt 14 abuts on the stop recess 30b when the holder 30A is tilted to the rightward and inclined at 45°.

As shown FIG. 1, a trough hole 30c extends frontward/rearward direction at a vertically intermediate position of the bracket 11B. A pin 33 is inserted trough the hole 30c (shown FIG. 1). When the pin 33 has been inserted trough the hole 30c, the pin 33 serves as a positioning member for providing the right-angle cutting position of the holder 30A.

A slide holder 30B it provided at the upper part of the holder 30A. The slide holder 30A has two through holes 30d (shown FIG. 2), which extend parallel to the upper surface of the turntable 11 and in the frontward/rearward direction thereof. Slide support members (not shown) are provided in these holes 30d, respectively. Further, two guide bars 34 extend through the holes 30d, respectively. The guide bars 34 are slidable frontward/rearward with respect to the slide holder 30B and in parallel to the upper surface of the turntable 11 through the slide support members (not shown). The cutting unit support 35 is attached to the front ends of the guide bars 34. Further, a cup 36 is fastened to the rear ends of the guide bars 34 for preventing the guide bars 34 from slipping out of the slide folder 30A. A knob 37 is mounted on one lateral side of the holder 30A (FIG. 3). The guide bars 34 can become temporality immovable by fastening the knob 37.

As shown FIG. 1, the cutting unit 20 is coupled to the top of the cutting unit support 35. The cutting unit 20 is pivotally connected to the cutting unit support 35 by a pivot shaft 22 that extends in parallel to the upper face of the base 10, and right angle to the frontward/rearward direction thereof. Therefore, the cutting unit 20 is pivotally movable up and down about the pivot shaft 22. A spring 23 is interposed between the cutting unit support 35 and the cutting unit 20 for normally biasing the cutting unit 20 upwards.

The cutting unit 20 has a main frame 24. The main frame 24 rotatably supports a saw shaft 25. The saw shaft 25 is the rotation shaft of the circular saw blade 21, and the circular saw blade 21 detachably secured to the saw shaft 25. A handle 26 and a motor 27 are mounted on the top of the main frame 24. The motor 27 is coupled to the saw shaft 25 to drive the circular saw blade 21. The handle 26 has a switch 28. The user operates the switch 28 with his finger for driving the motor 27.

As shown FIG. 1, a first laser oscillator 41 is attached on the downside of the handle 26 which downside is opposite to the upper surface of the base 10. The first laser oscillator 41 (functions as a first laser beam projecting device and) irradiates a first laser beam 42 to the workpiece W. The first laser beam 42 is red laser beam, and is only diffusely irradiated in a direction substantially perpendicular to the axis of the saw shaft 25. Therefore, a straight projection line of the first laser beam 42 is provided on the surface of the workpiece W. Moreover, the first laser beam 42 is irradiated in a direction parallel to the lateral side surface of the circular saw blade 21. Therefore, the projection line of the first laser beam 42 indicate an intersecting line between the circular saw blade 21 and the workpiece W regardless of the pivotal movement of the circular saw blade 21 toward and away from the turntable 11.

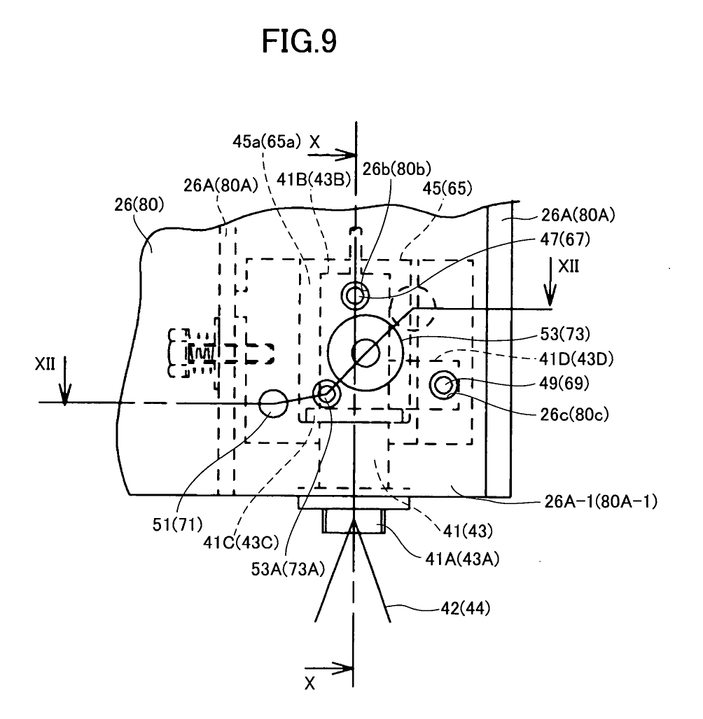

As shown FIG. 9, the first laser oscillator 42 includes a body 41B having a generally cylindrical shape, an irradiator 41A, a flange 41C, and a block peace 41D. The irradiator 41A is mounted on an axial end part of the body 41B. The flange 41C is disposed over an outer peripheral surface of the body 41B, and is located near the irradiator 41A. The block peace 41D is disposed at an opposite side of the irradiator 41A with respect to the flange 41C the axial direction of the body 41B. The block peace 41D extends from the outer peripheral surface of the body 41B in a diametrical direction thereof. The extending direction of the block peace 41D is orthogonal to the axis of the body 41B. The handle 26 has a housing 26A. The housing 26A houses a support member 45, which has accommodates therein first laser oscillator 41. That is, the support member 45 is formed with an inner space 45a in which the first laser oscillator 41 is installed.

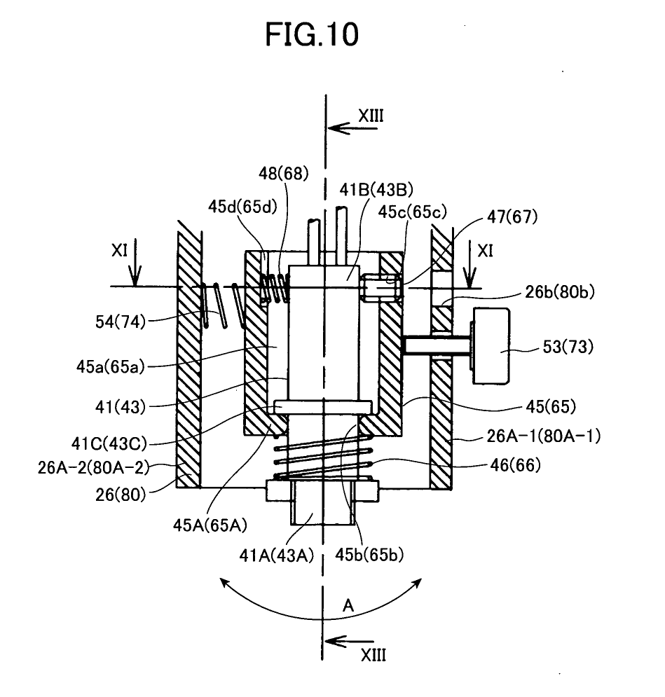

As shown FIG. 10, the support member 45 includes circular wall 45A located to define a lower end of the inner space 45a. The circular wall 45A is formed with a hole 45b. The body 41B is inserted in to the hole 45b from the side of the irradiator 41A, and the flange 41C abuts against the circular wall 45A as a result of insertion. A spring 46 is interposed between the irradiator 41A and the circular wall 45A after the body 41B has inserted in the hole 45b. Therefore, the first laser oscillator 41 is biased in a direction to protrude out of the support member 45. An inner peripheral surface of the hole 45b is shaped into a round shape in cross-section.

As shown in FIG. 10, the support member 45 is formed with a screw hole 45c at a position in confrontation with the body 41B. A screw 47 is threadingly engaged with the screw hole 45c. The support member 45 is formed with a spring seat 45d at an opposite side of the screw hole 45c with respect to the body 41B. A spring 46 is interposed between the body 41B and the spring seat 45d for biasing is the body 41B. Therefore, the body 41B is held between the spring 48 and the screw 47. The first laser oscillator 41 is rotatable and pivotable about the hole 45b serving as a fulcrum because the first laser oscillator 41 is supported to the round shaped surface of the hole 45b. Thus, the first laser oscillator 41 can be pivotally moved in a direction indicated by an arrow A about a contact point between the flange 41C and the circular wall 45A, by the threading advancement and/or retraction of the screw 47 relative to the screw hole 45c. Thus, parallel displacement occurs in the leftward of rightward in the laser beam projection line which is a straight line formed on the workpiece W and/or the turntable 11.

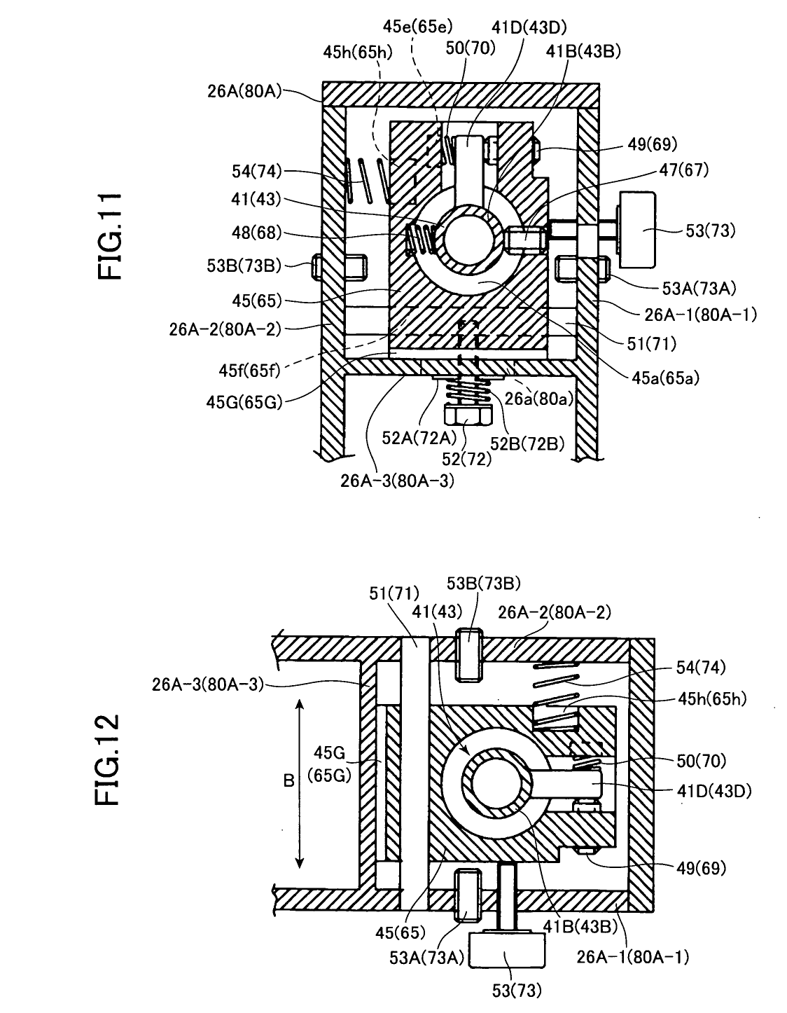

As shown in FIG. 11, the support member 45 is formed with a screw hole (not shown) at a position in confrontation with the block peace 41D. A screw 49 is threadingly engaged with the screw hole (not shown). The support member 45 is formed with a spring seat 45e at an opposite side of the screw hole (not shown) with respect to the block peace 41D. A spring 50 is interposed between the block peace 41D and the spring seat 45e for biasing the block peace 41D. Therefore, the flange 41C is held between the spring 50 and the screw 49. Thus, as shown in FIG. 14, the first laser oscillator 41 is rotatable in a direction indicated by an arrow C about the axis of the body 41B, by the threading advancement and/or retraction of the screw 49 relative to the screw hole (not shown). Thus, rotary displacement occurs in the leftward of rightward direction in the laser beam projection line which is a straight line formed on the workpiece W and/or the turntable 11.

As shown in FIG. 11, the support member 45 is formed with a pin hole 45f. The pin hole 45f extends in a direction in parallel with the extending direction of the screw 47. The housing 26A has a first wall 26A-1 and a second wall 26A-2, and extends through the pin hole 45f. Thus, the support member 45 is supported to the handle 26 by the pin 51. A minute gap is provided between the pin 51 and the pin hole 45f. Thus, the support member 45 can be slidally moved in a direction indicated by an arrow B in FIG. 12. Thus, parallel displacement occurs in the leftward of rightward direction in the laser beam projection line which is a straight line formed on the workpiece W and/or the turntable 11.

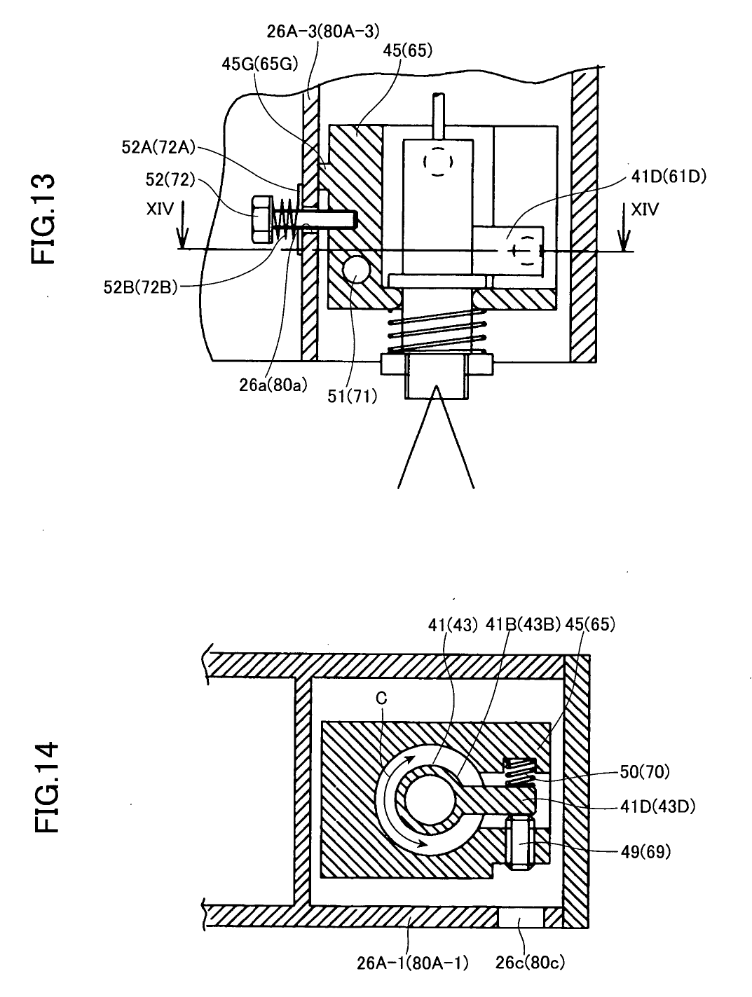

As shown in FIG. 12 and FIG. 13, the housing 26A has a third wall 26A-3 located between the first wall 26A-1 and the second wall 26A-2. Further, a convex member 45G is provided at a position in confrontation with the third wall 26A-3. The convex member 45G protrudes toward the third wall 26A-3 from the support member 45.

As shown in FIG. 11 and FIG. 13, the third wall 26A-3 is formed with a straight slot 26a extending in a direction parallel to the axial direction of the pin 51. The support member 45 is formed with a screw hole at a position in confrontation with the straight slot 26a. A knob 52 is threadingly engaged with the screw hole through the straight slot. 26a. A spring 52B and a washer 52A are interposed between the knob 52 and the third wall 26A-3. The washer 52A contacts with the third wall 26A-3 by the biasing force of the spring 52B seated on the knob 52. Thus, the support member 45 is biased toward to the third wall 26A-3, and the convex member 45G contacts with the third wall 26A-3. The washer 52A is slidally moved on the surface of the third wall 26A-3 when the support member 45 performs parallel displacement relative to the housing 26A. A friction between the washer 52A and the third wall 26A-3 can be increased in response to screwing the knob 52 into the screw hole, and the position of the support member 45 relative to the housing 26A can be fixed.

The first wall 26A-1 is formed with a screw hole at a position in confrontation with a first face of the support member 45 (shown in FIG. 11, FIG. 12). A knob 53 is threadingly engaged with the screw hole, and has a tip end abutting the first surface. The support member 45 has a second face provided at an opposite side of the first face. The second face is formed with a spring seat 45h. A spring 54 is interposed between the second wall 26A-2 and the spring seat 45h for biasing the support member 45 toward the knob 53. Therefore, the support member 45 is held between the spring 54 and the knob 53, and performs parallel displacement in an axial direction of the pin 51 indicated by the arrow B by the threading advancement or retraction of the knob 53. The first wall 26A-1 and the second wall 26A-2 are provided with a screw 53A and a screw 53B, respectively, each being abuttable on the support member 45. The support member 45 can perform parallel displacement between inner ends of the screw 53A, 53B. The position of the screw 53A and the screw 53B are adjusted for threading advancement or retraction thereof, so that a movable range of the support member 45 is greater than a thickness of the circular saw blade 21.

As shown in FIGS. 1 and 3, the cutting unit support 35 is provided with a laser oscillator holder 80. The laser oscillator holder 80 has a housing 80A, and the housing 80A accommodating therein a second laser oscillator 43 the same as the first laser oscillator 41. The second laser oscillator 43 irradiates a second laser beam 44 to the workpiece W. The second laser beam 44 is green laser beam, and is only diffusely irradiated in a direction substantially perpendicular to the axis of the saw shaft 25. Therefore, a straight projection line of the second laser beam 44 is provided on the surface of the workpiece W. Moreover, the second laser beam 44 is irradiated in a direction parallel to the lateral side surface of the circular saw blade 21. Therefore, the projection line of the second laser beam 44 indicates an intersecting line between the circular saw blade 21 and the workpiece W regardless of the pivotal movement of the cutting unit 20 toward and away from the turntable 11. The user can easily make a sharp distinction between the first laser beam 42 and the second laser beam 44, because the color of first laser beam 42 and the color of the second laser beam 44 are different from each other.

The second laser oscillator 43 provides a configuration substantially the same as that of the first laser oscillator 41. Further, components of a support member 65 for the second laser oscillator 43 is the same as components of the support member 45 for the first laser oscillator 41. Therefore, the description of the configuration of the second laser oscillator 43 will be omitted. The second laser oscillator 43 is only different from the first laser oscillator 41 such that a second laser beam 44 is irradiated to the workpiece W from the rear upper part thereof in the first beam oscillator 41, the first laser beam 42 is irradiated to the workpiece w from the immediate upper part thereof. Thus, the movement of the second laser beam 44 differs from the movement of the first laser beam 44 relative to the direction indicated by the arrows A (FIG. 10) and C (FIG. 14). Specifically, by the pivotal movement of the second laser oscillator 43 in the direction indicated by the arrow A (FIG. 10), angular displacement occurs in the leftward of rightward direction in the second laser beam 44 projection line which is a straight line formed on the workpiece W and/or the turntable 11. Further, by the movement of the second oscillator 43 in the direction indicated by the arrow C (FIG. 14), parallel displacement occurs in the leftward of rightward in the second laser beam 44 projection line which is a straight line formed on the workpiece W and/or the turntable 11. Furthermore, by the sliding movement of the support member 45 in a direction indicated by the arrow B (FIG. 12), parallel displacement occurs in the leftward of rightward direction in the second laser beam 44 projection line which is a straight line formed on the workpiece W and/or the turntable 11.

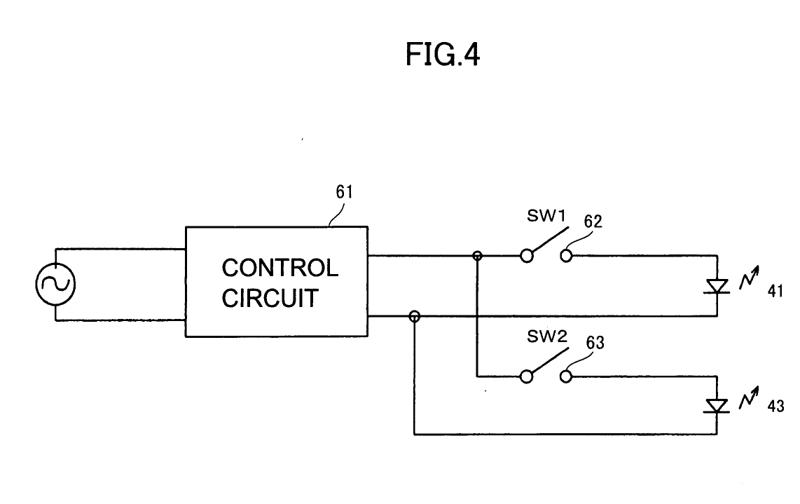

As shown in FIG. 4, a control circuit 61 is provided for converting an AC electric current into a DC electric current. The first laser oscillator 41 and the second laser oscillator 43 is supplied with the DC electric current. A switch 62 is provided between the control circuit 61 and the first laser oscillator 41, and another switch 62 is provided between the control circuit 61 and the second oscillator 43. The switch 62 and the switch 63 turn on and off the first laser oscillator 41 and the second laser oscillator 43, independently each other.

When the workpiece W is to be cut with the miter saw 1, the workpiece Abutted to the abutment surface 12A W and is fixed on the base 10 by the clump (not shown). Then, a rotation angle of the turntable 11 and a tilt angle of the cutting unit 20 are adjusted to given angles, and these angles are fixed. Further, the saw blade 21 is positioned above the workpiece W by slidingly moving the cutting unit support 35 in a direction of frontward/rearward relative to the slide holder 30B. Then, the switch 62 and 63 are turned on, so that the first laser beam 42 and the second laser beam 44 are irradiated onto the workpiece W from the first oscillator 41 and second oscillator 43, respectively. Therefore, a cutting line of the saw blade 21 is indicated on the workpiece W.

According to the above configuration, the second laser beam 44 is irradiated to the face of the workpiece W, abutting to the abutment surface 12A of the fence 12. Therefore, the second laser beam 44 can accurately indicates the cutting line of the saw blade 21 on the face. Further, even if the upper region of workpiece W has a variant face, the first laser beam 42 is irradiated onto the variant face. Therefore, no shade is formed on the variant face.

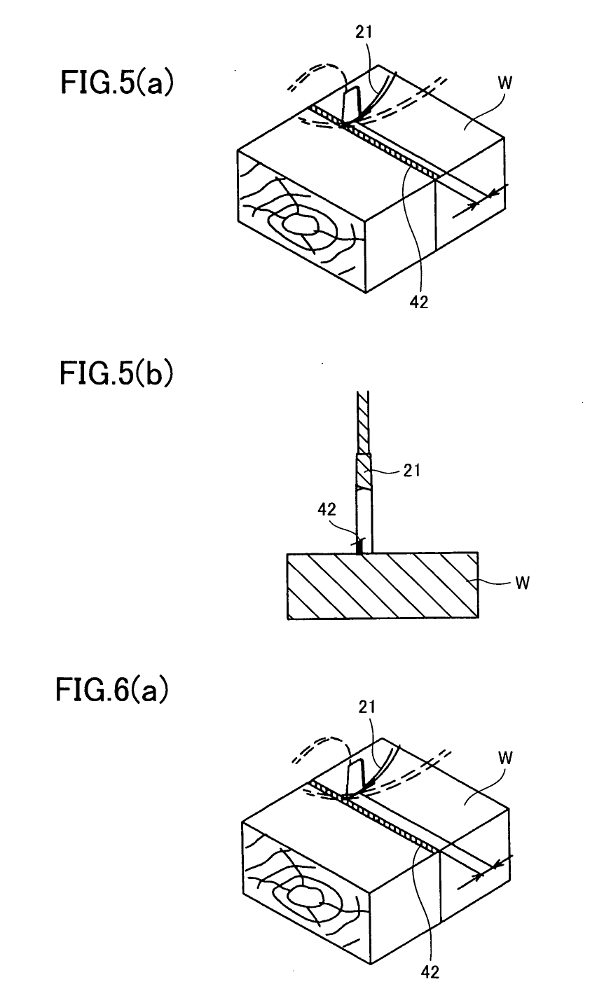

For indicating the cutting line by the laser beam, as shown in FIGS. 5(a) and 5(b), only the second laser beam 44 is irradiated within the thickness of the saw blade 21. The position of the second laser oscillator 43 is finely adjusted so as to place the widthwise edge of the projection line of the second laser beam 44 formed on the workpiece W at a position coincident with the lateral side of the saw blade 21, and to place the projection line within the thickness of the saw blade 21. Specifically, it is checked whether or not the straight beam line formed on the workpiece W and/or the turntable 11 by the laser beam 44 and a crossing line of the saw blade 21 relative to the surface of the workpiece W and/or the turntable 11 are parallel to each other. If the beam line is not parallel to the crossing line, the second laser oscillator 43 is adjusted so as to make the beam line to be parallel to or superposed with the crossing line by pivotally moving the body 43B in the direction indicated by the arrow A relative to the support member 65 by rotating the screw 67 with a screwdriver through the hole 80b which is formed at the first wall 80A-1 (shown in FIG. 10).

Next, it is checked whether or not the pivot moving trace of the saw blade 21, and the trace of the second laser beam 44 are parallel to or superposed with each other. If the trace of pivoting is not parallel to the trace of the second laser beam 44, the second laser oscillator 43 is adjusted so as to make the trace of pivoting to be parallel to or superposed with the trace of the second laser beam 44 by rotatably moving the body 43B in the direction indicated by the arrow C (shown in FIG. 14) relative to the support member 65 by rotating the screw 69 with a screwdriver through the hole 80c which is formed at the first wall 80A-1.

Further, the second laser oscillator 43 is adjusted so as to make the second laser beam 44 to be irradiated within the thickness of the saw blade 21 through horizontal migration of the support member 65 by rotating the knob 73. Because the spring 74 is provided at the opposite side of the knob 73 with respect to the support member 65, the support member 65 can be supported between the spring 74 and the knob 73 at an intended position. Therefore, the second laser beam 44 can be irradiated to a constant location.

In above instance, the second laser beam 44 is irradiated to the saw of the saw blade 21 at the cutting line on the workpiece W. That is, the laser beam projection line on the workpiece W is coincident with a cutting width of the saw blade 21.

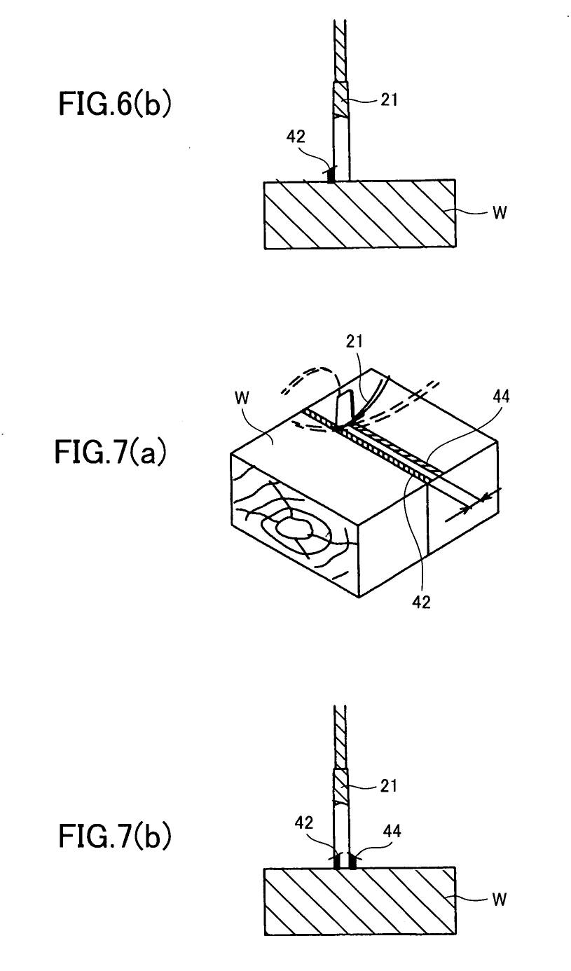

As another method of the cutting line by the laser beam, as shown in FIGS. 6(a) and 6(b), only the first laser beam 42 is irradiated outside of the thickness of the saw blade 21. The position of the first laser oscillator 41 is finely adjusted so as to place the widthwise edge of the projection line of the first laser beam 42 formed on the workpiece W at a position coincident with the lateral side of the saw blade 21, and to place the projection line outside of the thickness of the saw blade 21. Specifically, it is checked whether or not the straight beam line formed on the workpiece W and/or the turntable 11 by the first laser beam 42 and a crossing line of the saw blade 21 relative to the surface of the workpiece W and/or the turntable 11 are parallel to each other. If the beam line is not parallel to the crossing line, the first laser oscillator 41 is adjusted so as to make the beam line to be parallel to or superposed with the crossing line by rotatably moving the body 41B in the direction indicated by the arrow C (FIG. 14) relative to the support member 45 by rotating the screw 67 with a screwdriver through the hole 26c which is formed at the first wall 26A-1 (shown in FIG. 9) for moving the block peace 41D.

Next, it is checked whether or not the pivot moving trace of the saw blade 21, and the trace of the first laser beam 42 are parallel to or superposed with each other. If the trace of pivoting is not parallel to the trace of the first laser beam 42, the first laser oscillator 41 is adjusted so as to make the trace of pivoting to be parallel to or superposed with the trace of the first laser beam 42 by pivotally moving the body 41B in the direction indicated by the arrow A (shown in FIG. 10) relative to the support member 45 by rotating the screw 47 with a screwdriver through the hole 26b which is formed at the first wall 26A-1.

Further, the first laser oscillator 41 is adjusted so as to make the first laser beam 42 to be irradiated within the thickness of the saw blade 21 through horizontal migration of the support member 45 by rotating the knob 53. Because the spring 54 is provided at the opposite side of the knob 53 with respect to the support member 45, the support member 45 can be supported between the spring 54 and the knob 53 at an intended position. Therefore, the first laser beam 42 can be irradiated to a constant location. In this instance, the first laser beam 42 is irradiated to the saw of the saw blade 21 at the cutting line on the workpiece W. That is, the laser beam projection line on the workpiece W is coincident with a cutting width of the saw blade 21.

As another method of indicating the cutting line by the laser beam, as shown in FIGS. 7(a) and 7(b), the first laser beam 42 is irradiated outside of the thickness of the saw blade 21 and the second laser beam 44 is irradiated within the thickness of the saw blade 21. The position of the second laser oscillator 43 is finely adjusted so as to place the widthwise edge of the projection line of the first laser beam 42 formed on the workpiece W at a position coincident with the lateral side of the saw blade 21, and to place the projection line within the thickness of the saw blade 21. Further, the position of the first laser oscillator 41 is finely adjusted so as to place the widthwise edge of the projection line of the first laser beam 42 formed on the workpiece W at a position coincident with the lateral side of the saw blade 21, and to place the projection line outside of the thickness of the saw blade 21. The laser oscillator 41 and the laser oscillator 43 are finely adjusted in a manner the same as those described. Therefore, the description of the finely adjustments to the laser oscillator 41 and the laser oscillator 43 will be omitted. In this instance, the second laser beam 44 is irradiated to the cutting edge of the saw blade 21 and the first laser beam 42 is irradiated to a position immediately beside the cutting edge of the saw blade 21. That is, the position between the place of projection line of the second laser beam 44 and the edge of projection line of the first laser beam 42 is coincident with a cutting width of the saw blade 21.

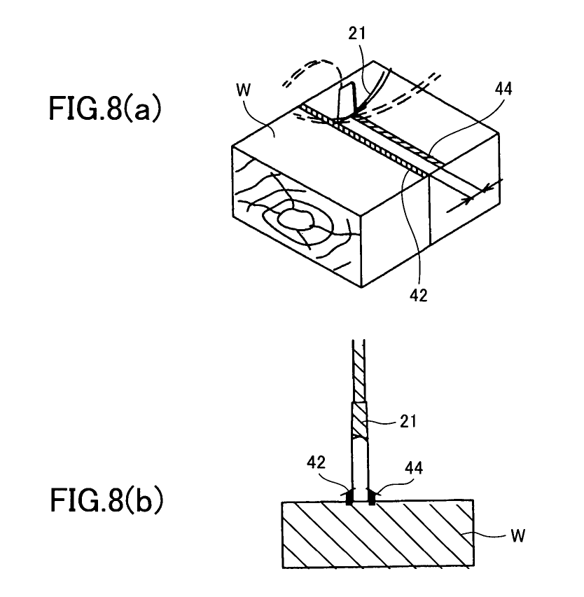

As another method of indicating the cutting line by the laser beam, as shown in FIGS. 8(a) and 8(b), the first laser beam 42 and the second laser beam 44 are irradiated outside of the thickness of the saw blade 21. The positions of the first laser oscillator 41 and second laser oscillator 43 are finely adjusted so as to place the widthwise edge of the projection line of the first laser beam 42 and the widthwise edge of the projection line of second laser beam 44 formed on the workpiece W at a position coincident with the each lateral sides of the saw blade 21 respectively, and to place the projection lines both outsides of the thickness of the saw blade 21 each other. The laser oscillator 41 and the laser oscillator 43 are finely adjusted in a manner the same as those described. Therefore, the description of the finely adjustments of the laser oscillator 41 and the laser oscillator 43 will be omitted. In this instance, the first laser beam 42 and the second laser beam 44 are irradiated to positions immediately besides the cutting edge of the saw blade 21. That is, the position between the edge of projection line of the first laser beam 42 and the edge of projection line of the second laser beam 44 is coincident with a cutting width of the saw blade 21.

After the cutting width is defined by one of above-mentioned methods, the user holds the handle 26 and operates the switch 28 to rotates the saw blade 21, and pivots the cutting unit 20 to downward for cutting the workpiece W along the cutting width. After cutting workpiece W, the user releases the pushing force to the cutting unit 20, so that the cutting unit 20 is pivotally moved to its uppermost position to restore its original posture by the biasing force of the spring 23 interposed between the cutting unit support 35 and the cutting unit 20.

For tiltingly moving the cutting unit 20, the clump lever 32 is unfastened after disengagement between the bracket 11B and the holder 30A by pulling the pin 33 rearward. Therefore, the cutting unit 20 becomes tiltable about the axis of the holder shaft 31. When the tilt angle of the cutting unit 20 has adjusted to desired angles, the cutting unit 20 is secured by fastening the clump lever 32. In this instance, because the first laser oscillator 41 and the second laser oscillator 43 are tiltingly moved as same as the saw blade 21, the positions of the saw blade 21, the first laser beam 42 and the second laser beam 44 relative to the workpiece W are not changed from the right-angle cutting position. Therefore, the user can perform fine adjustment to first laser oscillator 41 and second laser oscillator 43 whole the cutting unit 20 is tilting, in manner the same as the fine adjustment to the laser beams while the cutting unit 20 is at the vertical.

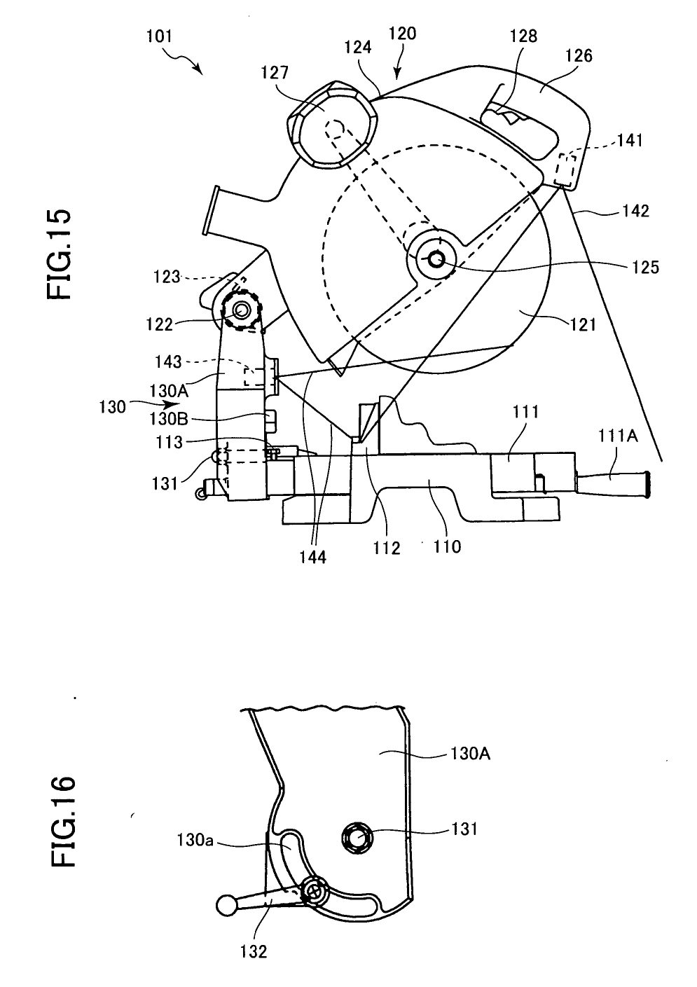

Next, a miter saw according to a second embodiment of the invention will be described with reference to FIG. 15 to FIG. 17. As shown in FIG. 15, the miter saw 101 includes a base 110, a turntable 111, a cutting unit 120, and a support section 130. The turntable 111 is supported on the base 110 and is rotatable about its axis with respect to the base 110. The cutting unit 120 rotatably supports a circular saw blade 121. The support section 130 stands upright from the rear portion of the turntable 111 to be pivotally movable. The support section 130 supports the cutting unit 120 movable toward and away from the turntable 111.

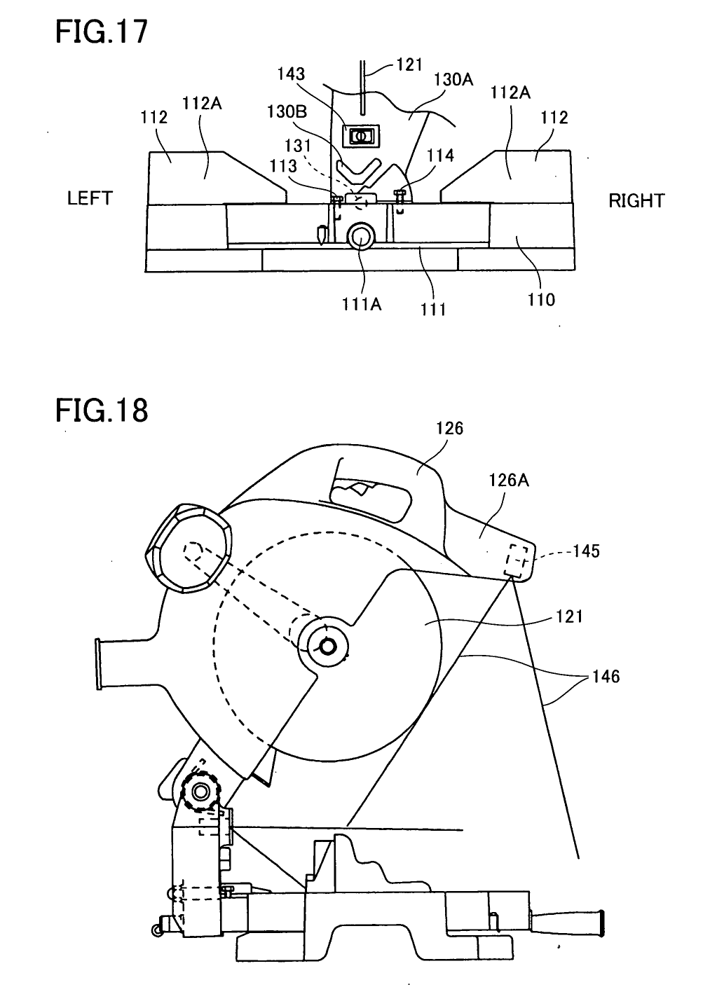

The turntable 111 is fitted, at its center part, with the center potion of the base 110 and is angularly rotatable in a horizontal plane. The upper surface of the turntable 111 is substantially flush with the upper surface of the base 110. A workpiece W such as a wood block is placed on the upper surfaces of the base 110 and turntable 111. A pair of fences 112 are secured to the upper surface of the base 110 and extend across the turntable 111 or along the diameter thereof. The fence 112 has a front surface serving as an abutment surface 112A on which the workpiece W is abutted for positioning the workpiece W. Note that the fences 112 are arrayed in a row that extends from the left to the right across the base 110 as shown in FIG. 17. The pair of fences 112 are spaced apart from each other at their inner ends, thus avoiding interference with the circular saw blade 121. Hereafter, throughout the specification, the abutment surface 112A side of the fences 112 is defined as a front side of the miter saw 101, and a rear side of the fence 112 opposite to the abutment surface 112A is defined as a rear side of the miter saw 101. A place of the cutting unit 120 side relative to the base 110 is defined as an upper side of the miter saw 101, and a place of the base 110 side relative to the cutting unit 120 is defined as a lower side of the miter saw 101. Then, a right side and a left side is defined in FIG. 17 as viewed from the front side of the miter saw 101.

A handle 111A extends from the turntable 111 radically outwardly and at the front side of the base 110. The turntable 111 can be angularly rotated about its axis relative the base 110 by moving the handle 111A rightward or leftward. A pair of plates (not shown) is fixed to the upper surface of the turntable 111. The pair of plates are separated from each other to provide a groove extending in a diametrical direction of the turntable 111 to allow a part of the circular saw blade 121 to be entered into the groove. Therefore, generation of fluff at the lower surface of the workpiece W can be prevented when the lower end of the circular saw blade 121 is moved past the upper surface of the turntable 111 during cutting, while the circular saw blade 121 is entered into the groove.

The support section 130 includes a holder 130A. The holder 130A is supported tiltable about a holder shaft 131 on the turntable 111. An axial direction of the holder shaft 131 coincides with a direction of the groove on the surface of the turntable 111. Therefore, the holder 130A is tiltingly movable about the holder shaft 131 to right side or left side, and when the holder 130A has pivotally moved, the circular saw blade 121 can enter the groove. Further, the groove has a sufficient width for allowing the past of the circular saw blade 121 to be entered therein even if the circular saw blade 121 is tilted leftward or rightward.

As shown in FIG. 16, the holder 130A is formed with an arcuate slot 130a. An imaginary center of radius of the arcuate slot 130a is coincident with the holder shaft 131. The turntable 111 is formed with a hole (not shown) at a position in confrontation with the arcuate slot 130a. A clump lever 132 has a screw part, which is threadingly engaged with the hole (not shown) of the turntable 111. The screw part passes through the arcuate slot 130a. If the clump lever 132 is unfastened, the holder 130A becomes tiltable about the axis of the holder shaft 131 as long as the clump lever 132 moves relative to the arcuate slot 130a. When the clump lever 132 is fastened, the clump lever 132 and the turntable 111 fixedly interpose therebetween the holder 130A. Thus, the holder 130A can be held at a desired inclined posture. The arcuate slot 130a has such a length that the holder 130A can be moved between the up-right position (hereinafter referred to as “right-angle cutting position”) as shown in FIG. 16 where the holder 130A stands at right angles to the base 110 and inclined position where the holder 130A inclines at 45° to the left and to the right.

As shown in FIG. 17, at the front part of the holder 130A, a stop segment 130B protruding out of the front surface of the holder 130A is provided. A shape of the stop segment 130B is formed like V character as viewed from the front side. The stop segment 130B is located near the base end part of the holder 130A the base end part being positioned close to the turntable 111. Screw holes extending vertically are formed at the upper surface of the rear part of the turntable 111. Stop bolts 113 and 114 are threadingly engaged with the screw holes. Heads of the stop bolts 113 and 114 are located above the upper surface of the turntable 111. The heads of the stop bolts 113 and 114 is controllable so as to define the rightmost and leftmost tilted positions of the holder 130A. That is, when the holder 130A is tilted leftward of rightward, the stop segment 130B is brought into abutment with associated one of the heads of the stop bolts 113 and 114. Thus, inclined position of the holder 130A at the leftmost position or rightmost position. The stop bolt 113 abuts on the stop segment 130B when the holder 130A is tilted to the leftward and inclined at 45°, and the stop bolt 114 abuts on the stop segment 130B when the holder 130A is tilted to the rightward and inclined at 45°.

As shown in FIG. 15, the cutting unit 120 is coupled to the top of the holder 130A. The cutting unit 120 is pivotally connected to the holder 130A by a pivot shaft 122 that extends in parallel to the upper face of the base 110, and perpendicular to the holder shaft 131. Therefore, the cutting unit 120 is pivotally movable up and down about the pivot shaft 122. A spring 123 is interposed between the holder 130A and the cutting unit 120 for normally biasing the cutting unit 120 upwards.

The cutting unit 120 has a main frame 124. The main frame 124 rotatably supports a saw shaft 125. The saw shaft 125 is the rotation shaft of the circular saw blade 121, and the circular saw blade 121 is detachably secured to the saw shaft 125. A handle 126 and a motor 127 are mounted on the top of the main frame 124. The motor 127 is drivingly connected to the saw shaft 125 to drive the circular saw blade 121. The handle 126 has a switch 128. The user operates the switch 128 with his finger for driving the motor 127.

As shown in FIG. 15, a first laser oscillator 141 is attached on the downside of the handle 126 which downside is opposite to the upper surface of the base 110. The first laser oscillator 141 irradiates a first laser beam 142 to the workpiece W. The first laser beam 142 is red laser beam, and is only diffusely irradiated in a direction substantially perpendicular to the axis of the saw shaft 125. Therefore, a straight projection line of the first laser beam 142 is provided on the surface of the workpiece W. Moreover, the first laser beam 142 is irradiated in a direction parallel to the lateral side surface of the circular saw blade 121. Therefore, the projection line of the first laser beam 142 indicate an intersecting line between the circular saw blade 121 and the workpiece W regardless of the pivotal movement of the circular saw blade 121 toward and away from the turntable 111.

As shown in FIGS. 15 and 17, the front surface side of the holder 130A accommodates a second laser oscillator 143 similar to the first laser oscillator 141. The second laser oscillator 143 irradiates a second laser beam 144 to the workpiece W. The second laser beam 144 is green laser beam, and is only diffusely irradiated in a direction substantially perpendicular to the axis of the saw shaft 125. Therefore, a straight projection line of the second laser beam 144 is provided on the surface of the workpiece W. Moreover, the second laser beam 144 is irradiated in a direction parallel to the lateral side surface of the circular saw blade 121. Therefore, the projection line of the second laser beam 144 indicates an intersecting line between the circular saw blade 121 and the workpiece W regardless of the pivotal movement of the cutting unit 120 toward and away from the turntable 11. The user can easily make a sharp distinction between the first laser beam 142 and the second laser beam 144, because the color of first laser beam 142 and the color of the second laser beam 144 are different from each other. The manner of fine adjustment to the position of the laser irradiating from the first laser oscillator 141 and the second laser oscillator 143 and the definition of the cutting width by the first laser beam 142 and second laser beam 144 the same as those of the first embodiment. Therefore, further description will be omitted.

A first modification to the second embodiment is shown in FIG. 18. An extension member 126A extending from the handle 126 accommodates a first laser oscillator 145. According to this arrangement, the first laser oscillator 145 can be provided away from the circular saw blade 121. Therefore the irradiation range of a first laser beam 146 from the first laser oscillator 145 to the circular saw blade 121 can be increased. Consequently, when the first laser beam 146 is irradiated within the thickness of the circular saw blade 121, the first laser beam 146 can indicate an intersecting line between the circular saw blade 121 and the workpiece W immediately before the circular saw blade 121 is abutted to the workpiece W. Thus, cutting accuracy can be increased.

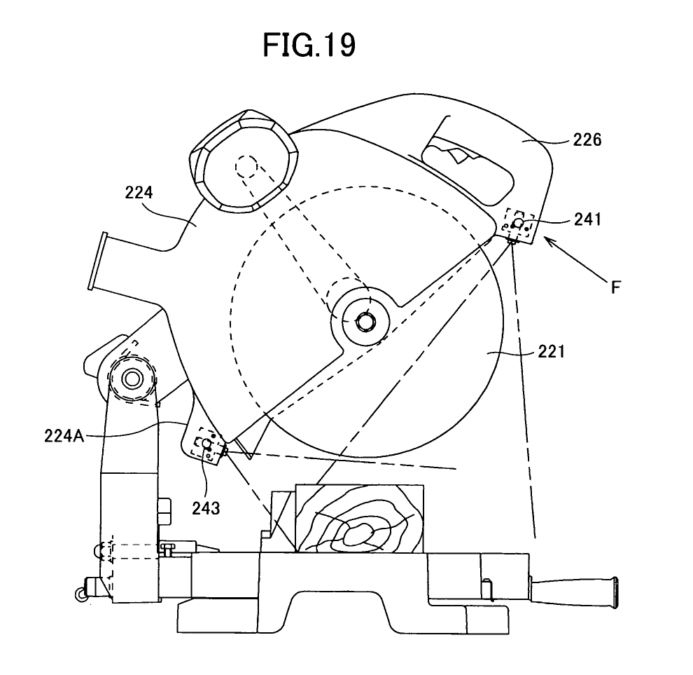

A second modification to the second embodiment is shown in FIG. 19, a first laser oscillator 241 is accommodated in a handle 226, and a second laser oscillator 243 is accommodated in an extension member 224A suspended from a main frame 224 and positioned at the opposite side of the handle 226 with respect to a circular saw blade 221.

While the invention has been described in detail and with reference to specific embodiments thereof, it would be apparent to those skilled in the art that various changes and modifications may be made therein without departing from the sprit and scope of the invention. For example, cutting width can be defined by a method other than the method in accordance with the first and second embodiments. Further, the above-described modifications are also available to the first embodiment.

What is claimed is:

1. A miter saw comprising:
a base on which a workpiece is to be mounted;
a cutting unit for rotatably supporting a circular saw blade;
a support section supported on the base and pivotably supporting the cutting unit movable toward and away from the base;
a fence extending in a lateral direction and fixed to the base and having a front surface to which the workpiece is to be abutted;
a first laser oscillator for irradiating a first laser beam to the workpiece from a front side of the front surface; and
a second laser oscillator for irradiating a second laser beam to the workpiece from a rear side of the front surface.

2. The miter saw as claimed in claim 1, wherein the fence has a rear surface which is an opposite side of the front surface, and the second laser oscillator is positioned and oriented to irradiate the second laser beam to the workpiece from a rear side of the rear surface.

3. The miter saw as claimed in claim 1, wherein the first laser oscillator is attached to the cutting unit.

4. The miter saw as claimed in claim 1, wherein the support section is tiltable in the lateral direction relative to the base, the second laser oscillator being attached to the support section.

5. The miter saw as claimed in claim 1, further comprising:
a first switch connected to the first laser oscillator for turning on/off the first laser oscillator; and
a second switch connected to the second laser oscillator for turning on/off the second laser oscillator.

6. The miter saw as claimed in claim 1, wherein the second laser beam provides a projection line which is indicative of an intersecting position between the workpiece and the circular saw blade moving toward the base.

7. The miter saw as claimed in claim 1, wherein the circular saw blade has a thickness and provides a locus in accordance with pivotal movement of the support section; and
wherein the second laser generator is configured to permit the second laser beam to be directed substantially parallel with the locus of the circular saw blade and to be passed within the thickness of the saw blade.

8. The miter saw as claimed in claim 1, wherein the circular saw blade has a side surface and provides a locus in accordance with pivotal movement of the support section; and
wherein the second laser generator is configured to permit the second laser beam to be directed substantially parallel with the locus of the circular saw blade and to be passed along the side surface of the saw blade.

9. The miter saw as claimed in claim 1, wherein the first laser beam provides a beam locus which is indicative of an intersecting position between the workpiece and the circular saw blade moving toward the base.

10. The miter saw as claimed in claim 1, wherein the circular saw blade has a thickness and provides a, locus in accordance with pivotal movement of the support section; and
wherein the first laser generator is configured to permit the first laser beam to be directed substantially parallel with the locus of the circular saw blade and to be passed within the thickness of the saw blade.

11. The miter saw as claimed in claim 1, wherein the circular saw blade has a side surface and provides a locus in accordance with pivotal movement of the support section; and
wherein the first laser generator is configured to permit the first laser beam to be directed substantially parallel with the locus of the circular saw blade and to be passed along the side surface of the saw blade.

12. The miter saw as claimed in claim 1, wherein the first laser beam provides a first color and the second laser beam provides a second color different from the first color.

13. The miter saw as claimed in claim 1, wherein the support section comprises:
a holder having one end supported to the base and having another end provided with a slide support portion; and
a slider slidably supported the slide support portion and movable in a direction parallel with a line which is an intersection between an upper surface of the base and the circular saw blade, the circular saw blade being pivotally movably connected to the slider.

14. The miter saw as claimed in claim 1, wherein the circular saw blade has a thickness; and
wherein the first laser oscillator has a first fine adjustment mechanism that finely adjusts an irradiating position of the first laser beam in a direction of the thickness; and
wherein the second laser oscillator has a second fine adjustment mechanism that finely adjusts an irradiating position of the second laser beam in the direction of the thickness.

15. The miter saw as claimed in claim 14, wherein the first fine adjustment mechanism and the second fine adjustment mechanism each provides a fine adjustable range greater than the thickness.
